(19) United States
(12) Patent Application Publication
(10) Pub. No.: US 2007/0013843 A1
(43) Pub. Date: Jan. 18, 2007

(54) Liquid crystal panel and liquid crystal display using the same

(76) Inventors: Yuuichi Nishikouji, Ibaraki-shi (JP); Hiroyuki Yoshimi, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/178,592

(22) Filed: Jul. 12, 2005

(51) Int. Cl. G02F 1/1335

(52) U.S. Cl. 349/119

(57) ABSTRACT

A liquid crystal panel that has a high contrast ratio over a wide range and can suppress color shifting effectively is provided. In a liquid crystal panel including between two polarizing plates arranged in a crossed Nicols state a birefringent layer A with nx>ny≧nz, a birefringent layer B with nx≧ny>nz and a VA-mode liquid crystal cell C, it is set that a wavelength dispersion characteristic (α40(A)) of the birefringent layer A, the birefringent layer B (α40(B)) and (α40(C)) of the liquid crystal cell C satisfy conditions α40(B)>α40(C)>α40(A) and 1>α40(A). The wavelength dispersion characteristic α40 represents a ratio of a retardation Re measured with incident light at 430 nm to that measured with incident light at 550 nm, the incident light being inclined by 40° with respect to a normal direction (0°) of a surface of the birefringent layer or a surface of the liquid crystal cell.

### BACKGROUND OF THE INVENTION

1. Field of the Invention

The present invention relates to a liquid crystal panel and a liquid crystal display using the same.

2. Description of Related Art

Conventionally, in liquid crystal displays, a so-called TN mode has been used primarily in which a liquid crystal having a positive dielectric constant anisotropy is horizontally aligned between substrates facing each other. However, the TN mode has driving characteristics in which liquid crystal molecules in the vicinity of the substrates generate birefringence even when attempting a black display, resulting in light leakage, making it difficult to achieve a perfect black display. On the other hand, there has been a VA mode in which liquid crystal molecules are aligned substantially vertically in a state where no voltage is applied. In the VA mode, since light passes through a liquid crystal layer while hardly changing its polarization plane, it is possible to achieve a substantially perfect black display in a non-driven state (in a state where no voltage is applied) by disposing polarizing plates above and below the substrate.

However, although a substantially perfect black display can be achieved in a direction normal to the panel in the VA mode, the influence of the birefringence of the liquid crystal becomes apparent when the panel is observed from a direction deviated from the normal direction (an oblique direction), leading to light leakage. As a result, the VA mode has had a problem that a viewing angle is small. In order to solve this problem, suggestion has been made to dispose a retardation plate having a refractive index anisotropy of nx=ny>nz in at least one of gaps between the liquid crystal layer and the polarizing plates, thereby compensating for the above-described birefringence of the liquid crystal (see JP 62(1987)-210423 A, for example). The above-mentioned nx, ny and nz respectively indicate refractive indices in an X-axis direction, a Y-axis direction and a Z-axis direction in the retardation plate. The X-axis direction is an axial direction exhibiting a maximum refractive index within the surface of the retardation plate, the Y-axis direction is an axial direction perpendicular to the X-axis direction within the surface, and the Z-axis direction is a thickness direction perpendicular to the X-axis direction and the Y-axis direction. However, even if the birefringence of the liquid crystal layer is compensated for, the light leakage due to the polarizing plates occurs in the directions deviated from an optical axis of the polarizing plates, causing a problem of lowering contrast. This is basically because, even if a crossed Nicols state is achieved with polarizers obtained by allowing a PVA-based film to adsorb a dichroic material such as iodine, light leakage occurs inevitably as a visual angle is inclined from the normal direction in the direction deviated from the optical axis.

On the other hand, a method has been suggested that uses both a first retardation plate having a positive refractive index anisotropy exhibiting nx>ny=nz and a second retardation plate having a negative refractive index anisotropy exhibiting nx=ny>nz so as to reduce the light leakage also in the direction deviated from the optical axis of the polarizing plate, thereby improving viewing angle characteristics (see Japanese Patent 3027805, for example). However, this method only improves the viewing angle characteristics in terms of contrast, in other words, it reduces a leakage amount with respect to light in the vicinity of 550 nm having the highest luminous factor but does not provide any solution for a color shifting. In terms of the viewing angle characteristics, the leakage amount has to be reduced also with respect to blue light and red light. In the case where it is not reduced sufficiently, a color shift phenomenon in which black becomes tinged with blue or red occurs. In other words, for improving the viewing angle characteristics of contrast, it is also necessary to consider the problem of color shift phenomenon.

Furthermore, it has been suggested to use an optically biaxial retardation plate exhibiting nx>ny>nz, thereby improving the viewing angle characteristics of a liquid crystal display in the VA mode (see Japanese Patent 3330574, for example). However, similarly to the above, this is also insufficient in terms of color shifting.

On the other hand, it has been reported in a recent study that, in a VA-mode liquid crystal display including a reciprocal dispersion A plate (nx>ny=nz) and a negative C plate (nx=ny>nz), the color shift phenomenon in black display can be improved slightly especially on a short wavelength side (see Y. Ono, et al.: IDW' 02 Proceedings, p. 525, for example). However, this method is also insufficient in terms of color shifting.

### SUMMARY OF THE INVENTION

The present invention was made with the foregoing in mind, and it is an object of the present invention to provide a VA-mode liquid crystal panel that has a high contrast ratio over a wide range and a suppressed color shifting.

In order to achieve the above-mentioned object, a liquid crystal panel according to the present invention includes two polarizing plates, a birefringent layer A, a birefringent layer B, and a liquid crystal cell C. The two polarizing plates are arranged such that their absorption axes are substantially orthogonal to each other, the birefringent layer A, the birefringent layer B and the liquid crystal cell C are arranged between the two polarizing plates, the birefringent layer A has a refractive index anisotropy represented by the formula (1) below, the birefringent layer B has a refractive index anisotropy represented by the formula (2) below, the liquid crystal cell C is a liquid crystal cell whose liquid crystal molecules are aligned substantially vertically when no voltage is applied, and a wavelength dispersion characteristic (α40(A)) of the birefringent layer A, the birefringent layer B (α40(B)) and (α40(C)) of the liquid crystal cell C satisfy conditions represented by the formulae (3) and (4) below,
nx>ny≧nz Formula (1)
nx≧ny>nz Formula (2)
where nx, ny and nz respectively represent refractive indices in an X-axis direction, a Y-axis direction and a Z-axis direction in the birefringent layers A and B, with the X-axis direction being an axial direction exhibiting a maximum refractive index within a surface of each of the birefringent layers A and B, the Y-axis direction being an axial direction perpendicular to the X-axis direction within the surface of each of the birefringent layers A and B and the Z-axis direction being a thickness direction perpendicular to the X-axis direction and the Y-axis direction,
α40(B)>α40(C)>α40(A) Formula (3)
1>α40(A) Formula (4)
where the wavelength dispersion characteristic α40 represents a ratio of a retardation (Re) measured with an incident light at 430 nm to that measured with an incident light at 550 nm, the incident lights being inclined by 40° with respect to a normal direction (0°) of a surface of the birefringent layer or a surface of the liquid crystal cell, as shown in the formula (5) below.
α40=Re(430 nm)/Re(550 nm) Formula (5)

Re(430 nm): the retardation measured with the incident light at 430 nm

Re(550 nm): the retardation measured with the incident light at 430 nm

### BRIEF DESCRIPTION OF THE DRAWINGS

FIG. 1 is a sectional view showing a configuration of an example of a liquid crystal panel according to the present invention.

FIG. 2 is a sectional view showing a configuration of another example of the liquid crystal panel according to the present invention.

FIG. 3 is a sectional view showing a configuration of yet another example of the liquid crystal panel according to the present invention.

FIG. 4 is a sectional view showing a configuration of yet another example of the liquid crystal panel according to the present invention.

FIG. 5 is a sectional view showing a configuration of yet another example of the liquid crystal panel according to the present invention.

### DETAILED DESCRIPTION OF THE INVENTION

In order to solve the problems described above, the inventors of the present invention conducted a series of studies. In the process thereof, the inventors focused attention to a transparent protective layer used for a polarizing plate. In other words, for obtaining a VA-mode liquid crystal display that suppresses light leakage sufficiently at each wavelength, it is necessary to note an optical influence of a transparent polymer film (for example, a triacetylcellulose (TAC) film) used as a transparent protective film on both sides of a polarizer. In general, the transparent polymer film has a refractive index anisotropy of nx≧ny>nz even in an unstretched state. In particular, since the retardation in thickness direction (nx−nz)d is as large as about 40 to 60 nm, light propagating in a direction inclined from the normal line of the film is influenced considerably, so that a retardation value of a birefringent layer needs to be set considering this influence. Furthermore, in order to protect liquid crystal molecules in a liquid crystal cell from ultraviolet light, the transparent protective film of the polarizing plate generally contains a UV absorber. Therefore, it has been concluded that, in order to remove the color shift phenomenon in the VA-mode liquid crystal display, wavelength dispersion characteristics of the birefringent layer have to be set so as to remove the optical influence of this UV absorber. Further studies conducted based on this revealed that, in the VA-mode liquid crystal panel, the birefringent layer A represented by the formula (1) and the birefringent layer B represented by the formula (2) are used such that they satisfy the relationships shown by the formulae (3) and (4) together with the liquid crystal cell C, thereby providing a VA-mode liquid crystal panel that has a high contrast ratio over a wide range and can suppress color shifting effectively, and thus the inventors arrived at the present invention. Therefore, the liquid crystal display including the liquid crystal panel according to the present invention has an excellent display quality because the contrast ratio is high over the wide range and the color shifting is suppressed.

In the present invention, the incident angle of the wavelength dispersion characteristics is set at 40° in the formulae (3) and (4) for the following reason.

With regard to an incident angle dependence of the wavelength dispersion, the liquid crystal molecules used in the cell have a greatly different wavelength dispersion between an ordinary index no and an extraordinary index ne. Thus, the wavelength dispersion of Δn=ne−no differs slightly depending on visual angles. In the case of the VA mode, since the liquid crystal molecules are aligned substantially vertically, Δn=0 when an incident angle is 0°, so that the wavelength dispersion cannot be measured. Accordingly, it is necessary to measure the wavelength dispersion while inclining incident light such that retardation is generated to a certain extent. However, an excessively large incident angle lowers a precision owing to an influence of surface reflection, etc. Consequently, it is preferable that the incident angle for measuring the wavelength dispersion characteristics is 40°. On the other hand, since the birefringent layer has substantially the same wavelength dispersion of the retardation regardless of visual angles, measurement at one angle is sufficient. Taking these points all into consideration, the incident angle of 40° is most appropriate.

In the present invention, it is preferable also in terms of the reduction in thickness and weight of the display apparatus that a difference in the refractive index (Δn=nx−ny, where nx and ny are the same as those in the formula (2)) within the surface of the birefringent layer B ranges from 0.005 to 0.2, because the thickness of the birefringent layer B can be reduced. Furthermore, the above-noted Δn preferably ranges from 0.008 to 0.17 and more preferably ranges from 0.01 to 0.15.

In the present invention, it is preferable that the birefringent layer B is formed of a non-liquid crystal material. The non-liquid crystal material is not particularly limited but can be polyamide, polyimide, polyester, polyetherketone, polyamide imide and polyesterimide. They may be used alone or in combination of two or more.

In the present invention, it is preferable that the polarizing plate includes a polarizer and transparent protective layers laminated on both surfaces of the polarizer, and one of the transparent protective layers that is located on a side of the liquid crystal cell C satisfies conditions represented by the formulae (6) and (7):
Re=(nx−ny)d<10 nm Formula (6)
Rth=(nx−nz)d<20 nm Formula (7)
where nx, ny and nz are the same as those in the formulae (1) and (2).

When the conditions represented by the formulae (6) and (7) above are satisfied, the contrast ratio in the oblique direction can be improved without affecting light propagating in the oblique direction.

In the present invention, it is preferable that the birefringent layer A and the birefringent layer B are laminated in this order on one of the polarizing plates. In this case, it is more preferable that the birefringent layer A is laminated on a polarizer of one of the polarizing plates, the birefringent layer A also serves as the transparent protective layer, a slow axis of the birefringent layer A and an absorption axis of the polarizer are substantially orthogonal to each other, and the birefringent layer B is laminated on the birefringent layer A. It is further preferable that the liquid crystal cell C is laminated on the birefringent layer B. In other words, the birefringent layer B and the liquid crystal cell C are adjacent to each other, whereby the birefringent layer B achieves a still better optical compensation for the liquid crystal cell C.

Now, the present invention will be described more in detail.

The liquid crystal panel according to the present invention has a configuration in which the birefringent layer A, the birefringent layer B and the liquid crystal cell C are arranged between two polarizing plates.

The material for forming the birefringent layer A is not particularly limited as long as it satisfies the formulae (1), (3) and (4) and is optically transparent.

In the case where cellulose acetate, for example, is used as the material for forming the birefringent layer A, it is known that the formula (4) can be satisfied by changing its acetylation degree.

The material for forming the birefringent layer A may be a blend or a copolymer of resins, for example. In the case of the blend, since the blend has to be optically transparent, a compatible blend, i.e., a blend in which individual polymers have substantially equal refractive indices is preferable. Specific combinations for the blend include, for example, a combination of poly(methyl methacrylate) as a polymer having a negative optical anisotropy and poly(vinylidene fluoride), poly(ethylene oxide) or poly(vinylidene fluoride-co-trifluoroethylene) as a polymer having a positive optical anisotropy, a combination of poly(phenylene oxide) as a polymer having a positive optical anisotropy and polystyrene, poly(styrene-co-lauroyl maleimide), poly(styrene-co-cyclohexyl maleimide) or poly(styrene-co-phenyl maleimide) as a polymer having a negative optical anisotropy, a combination of poly(styrene-co-maleic anhydride) having a negative optical anisotropy and polycarbonate having a positive optical anisotropy, a combination of poly(acrylonitrile-co-butadiene) having a positive optical anisotropy and poly(acrylonitrile-co-styrene) having a negative optical anisotropy, and the like. In terms of transparency, a combination of polystyrene and poly(phenylene oxide) such as poly(2,6-dimethyl-1,4-phenylene oxide) is preferable.

The above-noted copolymer can be, for example, poly(butadiene-co-polystyrene), poly(ethylene-co-polystyrene), poly(acrylonitrile-co-butadiene), poly(acrylonitrile-co-butadiene-co-styrene), a polycarbonate copolymer, a polyester copolymer, a polyester carbonate copolymer, a polyarylate copolymer or the like. Since a segment having a fluorene skeleton can achieve a negative optical anisotropy, a polycarbonate copolymer, a polyester copolymer, a polyester carbonate copolymer, a polyarylate copolymer and the like having a fluorene skeleton are preferable.

There is no particular limitation on how to produce the birefringent layer A. For example, it is appropriate to dissolve the above-mentioned material in a solvent so as to prepare a solution, coat a base film or a metallic endless belt whose surface is smooth with this solution so as to form a film, and then remove the solvent by evaporation, thereby forming the birefringent layer A.

The solvent for the coating solution is not particularly limited but can be, for example, halogenated hydrocarbons such as chloroform, dichloromethane, carbon tetrachloride, dichloroethane, tetrachloroethane, trichloroethylene, tetrachloroethylene, chlorobenzene and orthodichlorobenzene; phenols such as phenol and parachlorophenol; aromatic hydrocarbons such as benzene, toluene, xylene, methoxybenzene and 1,2-dimethoxybenzene; ketone-based solvents such as acetone, methyl ethyl ketone, methyl isobutyl ketone, cyclohexanone, cyclopentanone, 2-pyrrolidone and N-methyl-2-pyrrolidone; ester-based solvents such as ethyl acetate and butyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol and 2-methyl-2,4-pentanediol; amide-based solvents such as dimethylformamide and dimethylacetamide; nitrile-based solvents such as acetonitrile and butyronitrile; ether-based solvents such as diethyl ether, dibutyl ether and tetrahydrofuran; or carbon disulfide, ethyl cellosolve or butyl cellosolve. These solvents may be used alone or in combination of two or more.

The coating method of the solution can be, for example, spin coating, roller coating, flow coating, printing, dip coating, film flow-expanding, bar coating or gravure printing. At the time of coating, a laminating method of polymer layers also can be adopted, as necessary.

The material for forming the base film is not particularly limited, preferably is a polymer with excellent transparency and, because of its suitability for a stretching treatment and a shrinking treatment described later, preferably is a thermoplastic resin. Specific examples include acetate resins such as triacetylcellulose (TAC), polyester resins, polyethersulfone resins, polysulfone resins, polycarbonate resins, polyamide resins, polyimide resins, polyolefin resins, acrylic resins, polynorbornene resins (for example, trade name “ARTON” (manufactured by JSR Corporation), trade name “ZEONOR” and trade name “ZEONEX” (manufactured by ZEON Corporation)), cellulose resins, polyarylate resins, polystyrene resins, polyvinyl alcohol resins, polyvinyl chloride resins, polyvinylidene chloride resins, polyacrylic resins and a mixture thereof. Also, a liquid crystal polymer or the like can be used. Furthermore, it also is possible to use a mixture of a thermoplastic resin whose side chain has a substituted imido group or an unsubtituted imido group and a thermoplastic resin whose side chain has a substituted phenyl group or an unsubtituted phenyl group and a nitrile group as described in JP 2001-343529 A (WO 01/37007), for example. Specific examples thereof include a resin composition containing an alternating copolymer of isobutene and N-methylene maleimide and an acrylonitrile-styrene copolymer. Among these materials, a material that can set a relatively lower birefringence when the transparent film is formed is preferable. More specifically, the above-mentioned mixture of the thermoplastic resin whose side chain has a substituted imido group or an unsubtituted imido group and the thermoplastic resin whose side chain has a substituted phenyl group or an unsubtituted phenyl group and a nitrile group is preferable. Among these resins, representative examples are cellulose-based polymer films such as triacetylcellulose (TAC) films and norbornene-based polymer films (trade name “ARTON” (manufactured by JSR Corporation), trade name “ZEONOR” and trade name “ZEONEX” (manufactured by ZEON Corporation)).

The thickness of the base film is, for example, about 10 to 1000 μm, preferably 20 to 500 μm and more preferably 30 to 100 μm.

As the method for forming the birefringent layer A as the transparent protective layer of the polarizing plate, it is appropriate to coat a polarizer with the coating solution and remove the solvent by evaporation, thus forming the birefringent layer A, for example.

Also, in the present invention, the method for forming the birefringent layer A is not particularly limited to the above-described method.

Next, the liquid crystal cell C is a so-called VA mode liquid crystal cell, constituted by two liquid crystal cell substrates and liquid crystal molecules arranged between these substrates, in which the liquid crystal molecules are aligned substantially vertically when no voltage is applied. VA mode liquid crystal cells include, for example, not only (1) VA mode liquid crystal cells in a strict sense obtained by aligning rod-like liquid crystal molecules substantially vertically when no voltage is applied and aligning them substantially horizontally when a voltage is applied (described in JP 2(1990)-176625 A and JP 7(1995)-69536 A) but also (2) liquid crystal cells in multi-domain VA mode achieved for the purpose of increasing the viewing angle. More specifically, MVA (described in SID 97, Digest of tech. Papers (proceedings) 28 (1997) 845, SID 99, Digest of tech. Papers (proceedings) 30 (1999) 206 and JP 11(1999)-258605 A), SURVAIVAL (described in Monthly Display, vol. 6, No. 3 (1999) 14), PVA (described in Asia Display 98, Proc. of the 18th Inter. Display res. Conf. (proceedings) (1998) 383), Para-A (published in LCD/PDP International '99), DDVA (described in SID 98, Digest of tech. Papers (proceedings) 29 (1998) 838), EOC (described in SID 98, Digest of tech. Papers (proceedings) 29 (1998) 319), PSHA (described in SID 98, Digest of tech. Papers (proceedings) 29 (1998) 1081), RFFMH (described in Asia Display 98, Proc. of the 18th Inter. Display res. Conf. (proceedings) (1998) 375), HMD (described in SID 98, Digest of tech. Papers (proceedings) 29 (1998) 702) are included. Other than the above, (3) liquid crystal cells in a mode in which rod-like liquid crystal molecules are aligned substantially vertically when no voltage is applied and turned into a twisted multi-domain alignment when a voltage is applied (n-ASM mode) (described in IWD '98, Proc. of the 5th Inter. Display Workshop (proceedings) (1998) 143) are also included. Further, the wavelength dispersion characteristics α40(C) of the liquid crystal cell C basically is larger than 1 because the liquid crystal material used here exhibits a positive wavelength dispersion.

Now, the birefringent layer B is not particularly limited as long as it satisfies the formulae (2), (3) and (4). Also, in the birefringent layer B, Δn=nx−ny(nx≧ny) ranging from 0.005 to 0.2 makes it possible to reduce the thickness of the birefringent layer B and is also preferable in terms of the reduction in thickness and weight of the liquid crystal display. Furthermore, the above-noted Δn preferably ranges from 0.008 to 0.17 and more preferably ranges from 0.01 to 0.15. Moreover, since the birefringent layer B and the liquid crystal cell C are adjacent to each other, they desirably have smaller difference in retardation. Thus, it is preferable in the birefringent layer B that Rth=(nx−nz) d satisfies 1/2 of the retardation of the liquid crystal cell≧Rth≧3/2 of the retardation of the liquid crystal cell.

Although the method for forming the birefringent layer B is not specifically limited, it preferably is a non-liquid crystal material. The non-liquid crystal material preferably is a polymer such as polyamide, polyimide, polyester, polyetherketone, polyaryletherketone, polyamide imide and polyesterimide, for example, because of its excellent heat resistance, chemical resistance, transparency and hardness as described above. It may be possible to use one of these polymers alone or a mixture of two or more polymers having different functional groups, for example, a mixture of polyaryletherketone and polyamide. Among these polymers, polyimide is particularly preferable because of its high transparency, high alignment property and high stretching property.

The molecular weight of the above-mentioned polymer is not particularly limited, but the weight-average molecular weight (Mw) thereof preferably ranges from 1,000 to 1,000,000 and more preferably ranges from 2,000 to 500,000.

As the polyimide, it is preferable to use a polyimide that has a high in-plane alignment and is soluble in an organic solvent. More specifically, for example, it is possible to use a polymer containing a condensation polymer of 9,9-bis(aminoaryl)fluorene and an aromatic tetracarboxylic dianhydride disclosed in JP 2000-511296 A and containing at least one repeating unit represented by the general formula (1) below.

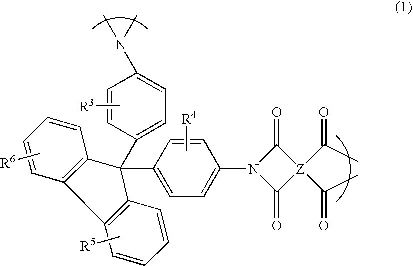

In the above general formula (1), R³ to R⁶ are at least one substituent selected independently from the group consisting of a hydrogen atom, a halogen atom, a phenyl group, a phenyl group substituted with 1 to 4 halogen atoms or a C₁₋₁₀ alkyl group, and a C₁₋₁₀ alkyl group. Preferably, R³ to R⁶ are at least one substituent selected independently from the group consisting of a halogen atom, a phenyl group, a phenyl group substituted with 1 to 4 halogen atoms or a C₁₋₁₀ alkyl group, and a C₁₋₁₀ alkyl group.

In the above general formula (1), Z is, for example, a C₆₋₂₀ quadrivalent aromatic group, and preferably is a pyromellitic group, a polycyclic aromatic group, a derivative of a polycyclic aromatic group or a group represented by the general formula (2) below.

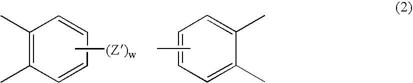

In the general formula (2) above, Z′ is, for example, a covalent bond, a C(R⁷)₂ group, a CO group, an O atom, an S atom, an SO₂ group, an Si(C₂H₅)₂ group or an NR⁸ group. When there are plural Z's, they may be the same or different. Also, w is an integer from 1 to 10. R⁷s independently are a hydrogen atom or C(R⁹)₃. R⁸ is a hydrogen atom, a C₁₋₂₀ alkyl group or a C₆₋₂₀ aryl group, and when there are plural R⁸s, they may be the same or different. R⁹s independently are a hydrogen atom, a fluorine atom or a chlorine atom.

The above-mentioned polycyclic aromatic group may be, for example, a quadrivalent group derived from naphthalene, fluorene, benzofluorene or anthracene. Further, a substituted derivative of the above-mentioned polycyclic aromatic group may be the above-mentioned polycyclic aromatic group substituted with at least one group selected from the group consisting of, for example, a C₁₋₁₀ alkyl group, a fluorinated derivative thereof and a halogen atom such as an F atom and a Cl atom.

Other than the above, homopolymer whose repeating unit is represented by the general formula (3) or (4) below or polyimide whose repeating unit is represented by the general formula (5) below disclosed in JP 8(1996)-511812 A may be used, for example. The polyimide represented by the general formula (5) below is a preferable mode of the homopolymer represented by the general formula (3).

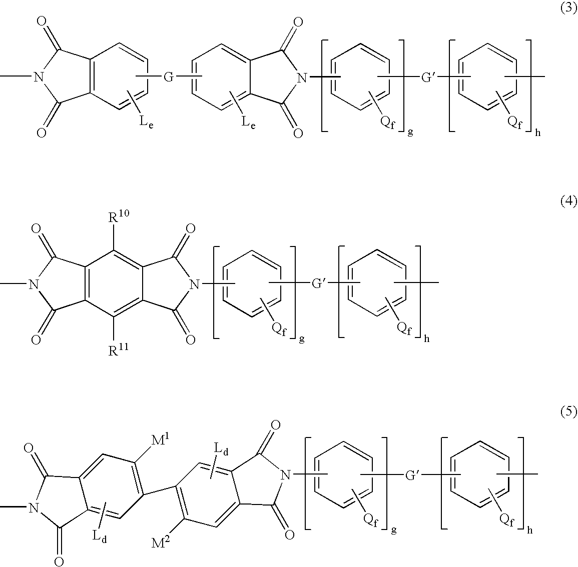

In the above general formulae (3) to (5), G and G′ each are a group selected independently from the group consisting of, for example, a covalent bond, a CH₂ group, a C(CH₃)₂ group, a C(CF₃)₂ group, a C(CX₃)₂ group (wherein X is a halogen atom), a CO group, an O atom, an S atom, an SO₂ group, an Si(CH₂CH₃)₂ group and an N(CH₃) group, and G and G′ may be the same or different.

In the above general formulae (3) and (5), L is a substituent, and d and e indicate the number of substitutions therein. L is, for example, a halogen atom, a C₁₋₃ alkyl group, a halogenated C₁₋₃ alkyl group, a phenyl group or a substituted phenyl group, and when there are plural Ls, they may be the same or different. The above-mentioned substituted phenyl group may be, for example, a substituted phenyl group having at least one substituent selected from the group consisting of a halogen atom, a C₁₋₃ alkyl group and a halogenated C₁₋₃ alkyl group. Also, the above-mentioned halogen atom may be, for example, a fluorine atom, a chlorine atom, a bromine atom or an iodine atom. d is an integer from 0 to 2, and e is an integer from 0 to 3.

In the above general formulae (3) to (5), Q is a substituent, and f indicates the number of substitutions therein. Q may be, for example, an atom or a group selected from the group consisting of a hydrogen atom, a halogen atom, an alkyl group, a substituted alkyl group, a nitro group, a cyano group, a thioalkyl group, an alkoxy group, an aryl group, a substituted aryl group, an alkyl ester group and a substituted alkyl ester group and, when there are plural Qs, they may be the same or different. The above-mentioned halogen atom may be, for example, a fluorine atom, a chlorine atom, a bromine atom or an iodine atom. The above-mentioned substituted alkyl group may be, for example, a halogenated alkyl group. Also, the above-mentioned substituted aryl group may be, for example, a halogenated aryl group. f is an integer from 0 to 4, and g and h respectively are an integer from 0 to 3 and an integer from 1 to 3. Furthermore, it is preferable that g and h are larger than 1.

In the above general formula (4), R¹⁰ and R¹¹ are groups selected independently from the group consisting of a hydrogen atom, a halogen atom, a phenyl group, a substituted phenyl group, an alkyl group and a substituted alkyl group. It is particularly preferable that R¹⁰ and R¹¹ independently are a halogenated alkyl group.

In the above general formula (5), M¹ and M² may be the same or different and, for example, a halogen atom, a C₁₋₃ alkyl group, a halogenated C₁₋₃ alkyl group, a phenyl group or a substituted phenyl group. The above-mentioned halogen atom may be, for example, a fluorine atom, a chlorine atom, a bromine atom or an iodine atom. The above-mentioned substituted phenyl group may be, for example, a substituted phenyl group having at least one substituent selected from the group consisting of a halogen atom, a C₁₋₃ alkyl group and a halogenated C₁₋₃ alkyl group.

A specific example of polyimide represented by the general formula (3) includes polyimide represented by the general formula (6) below.

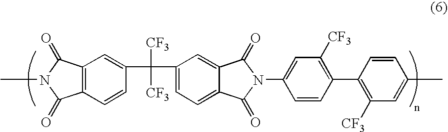

Moreover, the above-mentioned polyimide may be, for example, copolymer obtained by copolymerizing acid dianhydride and diamine other than the above-noted skeleton (the repeating unit) suitably.

The above-mentioned acid dianhydride may be, for example, aromatic tetracarboxylic dianhydride. The aromatic tetracarboxylic dianhydride may be, for example, pyromellitic dianhydride, benzophenone tetracarboxylic dianhydride, naphthalene tetracarboxylic dianhydride, heterocyclic aromatic tetracarboxylic dianhydride or 2,2′-substituted biphenyl tetracarboxylic dianhydride.

The pyromellitic dianhydride may be, for example, pyromellitic dianhydride, 3,6-diphenyl pyromellitic dianhydride, 3,6-bis(trifluoromethyl)pyromellitic dianhydride, 3,6-dibromopyromellitic dianhydride or 3,6-dichloropyromellitic dianhydride. The benzophenone tetracarboxylic dianhydride may be, for example, 3,3′,4,4′-benzophenone tetracarboxylic dianhydride, 2,3,3′, 4′-benzophenone tetracarboxylic dianhydride or 2,2′,3,3′-benzophenone tetracarboxylic dianhydride. The naphthalene tetracarboxylic dianhydride may be, for example, 2,3,6,7-naphthalene-tetracarboxylic dianhydride, 1,2,5,6-naphthalene-tetracarboxylic dianhydride or 2,6-dichloro-naphthalene-1,4,5,8-tetracarboxylic dianhydride. The heterocyclic aromatic tetracarboxylic dianhydride may be, for example, thiophene-2,3,4,5-tetracarboxylic dianhydride, pyrazine-2,3,5,6-tetracarboxylic dianhydride or pyridine-2,3,5,6-tetracarboxylic dianhydride. The 2,2′-substituted biphenyl tetracarboxylic dianhydride may be, for example, 2,2′-dibromo-4,4′,5,5′-biphenyl tetracarboxylic dianhydride, 2,2′-dichloro-4,4′, 5,5′-biphenyl tetracarboxylic dianhydride or 2,2′-bis(trifluoromethyl)-4,4′, 5, 5′-biphenyl tetracarboxylic dianhydride.

Other examples of the aromatic tetracarboxylic dianhydride may include 3,3′,4,4′-biphenyl tetracarboxylic dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)-1,1,1,3,3,3-hexafluoropropane dianhydride, 4,4′-bis(3,4-dicarboxyphenyl)-2,2-diphenylpropane dianhydride, bis(3,4-dicarboxyphenyl)ether dianhydride, 4,4′-oxydiphthalic dianhydride, bis(3,4-dicarboxyphenyl)sulfonic dianhydride, 3,3′,4,4′-diphenylsulfone tetracarboxylic dianhydride, 4,4′-[4,4′-isopropylidene-di(p-phenyleneoxy)]bis(phthalic dianhydride), N,N-(3,4-dicarboxyphenyl)-N— methylamine dianhydride and bis(3,4-dicarboxyphenyl)diethylsilane dianhydride.

Among the above, the aromatic tetracarboxylic dianhydride preferably is 2,2′-substituted biphenyl tetracarboxylic dianhydride, more preferably is 2,2′-bis(trihalomethyl)-4,4′, 5,5′-biphenyl tetracarboxylic dianhydride, and further preferably is 2,2′-bis(trifluoromethyl)-4,4′, 5,5′-biphenyl tetracarboxylic dianhydride.

The above-mentioned diamine may be, for example, aromatic diamine. Specific examples thereof include benzenediamine, diaminobenzophenone, naphthalenediamine, heterocyclic aromatic diamine and other aromatic diamines.

The benzenediamine may be, for example, diamine selected from the group consisting of benzenediamines such as o-, m- and p-phenylenediamine, 2,4-diaminotoluene, 1,4-diamino-2-methoxybenzene, 1,4-diamino-2-phenylbenzene and 1,3-diamino-4-chlorobenzene. Examples of the diaminobenzophenone may include 2,2′-diaminobenzophenone and 3,3′-diaminobenzophenone. The naphthalenediamine may be, for example, 1,8-diaminonaphthalene or 1,5-diaminonaphthalene. Examples of the heterocyclic aromatic diamine may include 2,6-diaminopyridine, 2,4-diaminopyridine and 2,4-diamino-5-triazine.

Further, other than the above, the aromatic diamine may be 4,4′-diaminobiphenyl, 4,4′-diaminodiphenyl methane, 4,4′-(9-fluorenylidene)-dianiline, 2,2′-bis(trifluoromethyl)-4,4′-diaminobiphenyl, 3,3′-dichloro-4,4′-diaminodiphenyl methane, 2,2′-dichloro-4,4′-diaminobiphenyl, 2,2′, 5,5′-tetrachlorobenzidine, 2,2-bis(4-aminophenoxyphenyl)propane, 2,2-bis(4-aminophenyl)propane, 2,2-bis(4-aminophenyl)-1,1,1,3,3,3-hexafluoropropane, 4,4′-diamino diphenyl ether, 3,4′-diamino diphenyl ether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis[4-(4-aminophenoxy)phenyl]propane, 2,2-bis [4-(4-aminophenoxy)phenyl]-1,1,1,3,3,3,-hexafluoropropane, 4,4′-diamino diphenyl thioether or 4,4′-diaminodiphenylsulfone.

The above-mentioned polyetherketone may be, for example, polyaryletherketone represented by the general formula (7) below, which is disclosed in JP 2001-49110 A.

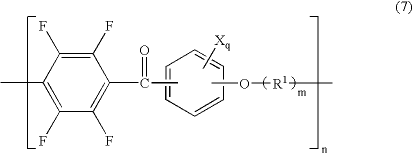

In the above general formula (7), X is a substituent, and q is the number of substitutions therein. X is, for example, a halogen atom, a lower alkyl group, a halogenated alkyl group, a lower alkoxy group or a halogenated alkoxy group, and when there are plural Xs, they may be the same or different.

The halogen atom may be, for example, a fluorine atom, a bromine atom, a chlorine atom or an iodine atom, and among these, a fluorine atom is preferable. The lower alkyl group preferably is a C₁₋₆ lower straight alkyl group or a C₁₋₆ lower branched alkyl group and more preferably is a C₁₋₄ straight or branched chain alkyl group, for example. More specifically, it preferably is a methyl group, an ethyl group, a propyl group, an isopropyl group, a butyl group, an isobutyl group, a sec-butyl group or a tert-butyl group, and particularly preferably is a methyl group or an ethyl group. The halogenated alkyl group may be, for example, a halide of the above-mentioned lower alkyl group such as a trifluoromethyl group. The lower alkoxy group preferably is a C₁₋₆ straight or branched chain alkoxy group and more preferably is a C₁₋₄ straight or branched chain alkoxy group, for example. More specifically, it further preferably is a methoxy group, an ethoxy group, a propoxy group, an isopropoxy group, a butoxy group, an isobutoxy group, a sec-butoxy group or a tert-butoxy group, and particularly preferably is a methoxy group or an ethoxy group. The halogenated alkoxy group may be, for example, a halide of the above-mentioned lower alkoxy group such as a trifluoromethoxy group.

In the above general formula (7), q is an integer from 0 to 4. In the general formula (7), it is preferable that q=0 and a carbonyl group and an oxygen atom of an ether that are bonded to both ends of a benzene ring are present at para positions.

Also, in the above general formula (7), R¹ is a group represented by the general formula (8) below, and m is an integer of 0 or 1.

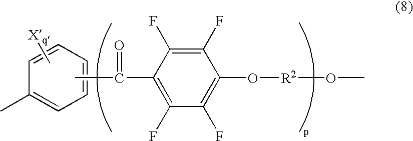

In the above general formula (8), X′ is a substituent and is the same as X in the general formula (7), for example. In the general formula (8), when there are plural X's, they may be the same or different. q′ indicates the number of substitutions in the X′ and is an integer from 0 to 4, preferably, q′=0. In addition, p is an integer of 0 or 1.

In the general formula (8), R² is a divalent aromatic group. This divalent aromatic group is, for example, an o-, m- or p-phenylene group or a divalent group derived from naphthalene, biphenyl, anthracene, o-, m- or p-terphenyl, phenanthrene, dibenzofuran, biphenyl ether or biphenyl sulfone. In these divalent aromatic groups, a hydrogen atom that is bonded directly to the aromatic may be substituted with a halogen atom, a lower alkyl group or a lower alkoxy group. Among them, the R² preferably is an aromatic group selected from the group consisting of the general formulae (9) to (15) below.

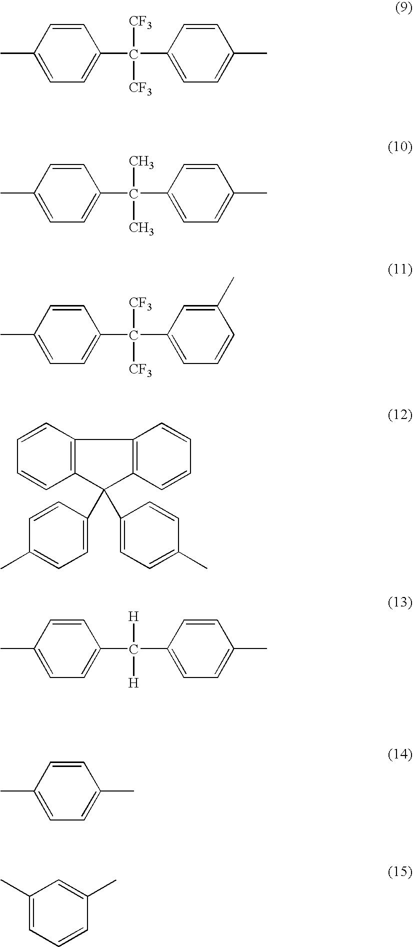

In the above general formula (7), the R¹ preferably is a group represented by the general formula (16) below, wherein R² and p are equivalent to those in the above-noted general formula (8).

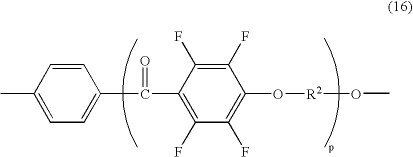

Furthermore, in the general formula (7), n indicates a degree of polymerization ranging, for example, from 2 to 5000 and preferably from 5 to 500. The polymerization may be composed of repeating units with the same structure or those with different structures. In the latter case, the polymerization form of the repeating units may be a block polymerization or a random polymerization.

Moreover, it is preferable that an end on a p-tetrafluorobenzoylene group side of the polyaryletherketone represented by the general formula (7) is fluorine and an end on an oxyalkylene group side thereof is a hydrogen atom. Such a polyaryletherketone can be represented by the general formula (17) below, for example. In the general formula (17) below, n indicates a degree of polymerization as in the general formula (7).

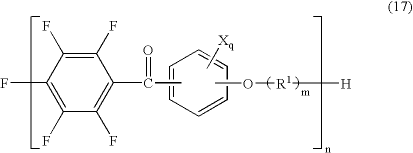

Specific examples of the polyaryletherketone represented by the general formula (7) may include those represented by the general formulae (18) to (21) below, wherein n indicates a degree of polymerization as in the general formula (7).

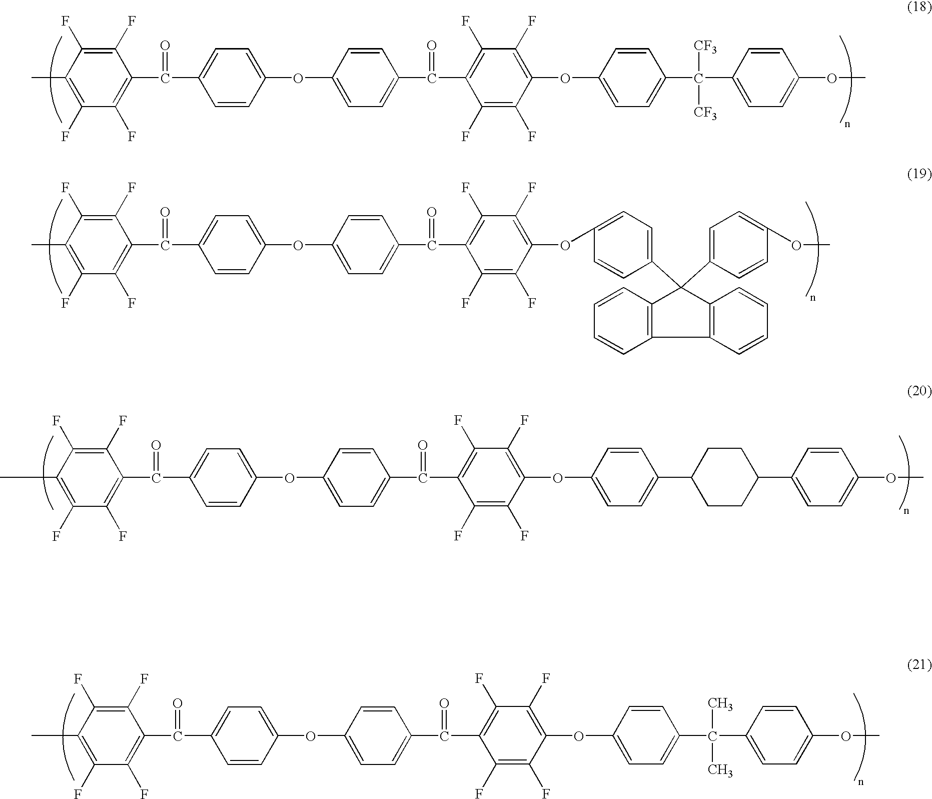

Other than the above, the above-mentioned polyamide or polyester may be, for example, polyamide or polyester described by JP 10(1998)-508048 A, and their repeating units can be represented by the general formula (22) below, for example.

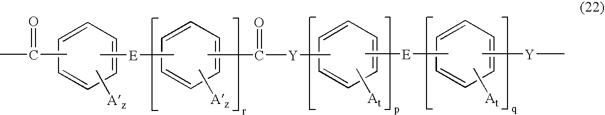

In the above general formula (22), Y is an O atom or an NH atom. E is, for example, at least one group selected from the group consisting of a covalent bond, a C₂ alkylene group, a halogenated C₂ alkylene group, a CH₂ group, a C(CX₃)₂ group (wherein X is a halogen atom or a hydrogen atom), a CO group, an O atom, an S atom, an SO₂ group, an Si(R)₂ group and an N(R) group, and Es may be the same or different. In the above-mentioned E, R is at least one of a C₁₋₃ alkyl group and a halogenated C₁₋₃ alkyl group and present at a meta position or a para position with respect to a carbonyl functional group or a Y group.

Further, in the above general formula (22), A and A′ are substituents, and t and z respectively indicate the numbers of substitutions therein. Additionally, p is an integer from 0 to 3, q is an integer from 1 to 3, and r is an integer from 0 to 3.

The above-mentioned A is selected from the group consisting of, for example, a hydrogen atom, a halogen atom, a C₁₋₃ alkyl group, a halogenated C₁₋₃ alkyl group, an alkoxy group represented by OR (wherein R is the group defined above), an aryl group, a substituted aryl group by halogenation, a C₁₋₉ alkoxycarbonyl group, a C₁₋₉ alkylcarbonyloxy group, a C₁₋₁₂ aryloxycarbonyl group, a C₁₋₁₂ arylcarbonyloxy group and a substituted derivative thereof, a C₁₋₁₂ arylcarbamoyl group, and a C₁₋₁₂ arylcarbonylamino group and a substituted derivative thereof. When there are plural As, they may be the same or different. The above-mentioned A′ is selected from the group consisting of, for example, a halogen atom, a C₁₋₃ alkyl group, a halogenated C₁₋₃ alkyl group, a phenyl group and a substituted phenyl group and when there are plural A's, they may be the same or different. A substituent on a phenyl ring of the substituted phenyl group can be, for example, a halogen atom, a C₁₋₃ alkyl group, a halogenated C₁₋₃ alkyl group or a combination thereof. The t is an integer from 0 to 4, and the z is an integer from 0 to 3.

Among the repeating units of the polyamide or polyester represented by the general formula (22) above, the repeating unit represented by the general formula (23) below is preferable.

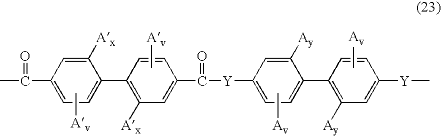

In the general formula (23), A, A′ and Y are those defined by the general formula (22), and v is an integer from 0 to 3, preferably is an integer from 0 to 2. Although each of x and y is 0 or 1, not both of them are 0.

There is no particular limitation on how to produce the birefringent layer B. For example, it is appropriate to dissolve the above-mentioned material in a solvent so as to prepare a solution, coat a base film or a metallic endless belt whose surface is smooth with this solution so as to form a film, and then remove the solvent by evaporation, thereby forming the birefringent layer B.

The material for forming the base film is not particularly limited, but preferably is a polymer with excellent optical transparency and, because of its suitability for a stretching treatment and a shrinking treatment described later, preferably is a thermoplastic resin. Specific examples include acetate resins such as triacetylcellulose (TAC), polyester resins, polyethersulfone resins, polysulfone resins, polycarbonate resins, polyamide resins, polyimide resins, polyolefin resins, acrylic resins, polynorbornene resins (for example, trade name “ARTON”) (manufactured by JSR Corporation), trade name “ZEONOR”, trade name “ZEONEX” (manufactured by ZEON Corporation), cellulose resins, polyarylate resins, polystyrene resins, polyvinyl alcohol resins, polyvinyl chloride resins, polyvinylidene chloride resins, polyacrylic resins and a mixture thereof. Also, a liquid crystal polymer or the like can be used. Furthermore, it also is possible to use a mixture of a thermoplastic resin whose side chain has a substituted imido group or an unsubtituted imido group and a thermoplastic resin whose side chain has a substituted phenyl group or an unsubtituted phenyl group and a nitrile group as described in JP 2001-343529 A (WO 01/37007), for example. Specific examples thereof include a resin composition containing an alternating copolymer of isobutene and N-methylene maleimide and an acrylonitrile-styrene copolymer. Among these materials, a material that can set a relatively lower birefringence when the transparent film is formed is preferable. More specifically, the above-mentioned mixture of the thermoplastic resin whose side chain has a substituted imido group or an unsubtituted imido group and the thermoplastic resin whose side chain has a substituted phenyl group or an unsubtituted phenyl group and a nitrile group is preferable. Among these resins, representative examples are cellulose-based polymer films such as triacetylcellulose (TAC) films and norbornene-based polymer films (trade name “ARTON” (manufactured by JSR Corporation), trade name “ZEONOR”, trade name “ZEONEX” (manufactured by ZEON Corporation), etc.).

The thickness of the base film is, for example, about 10 to 1000 μm, preferably 20 to 500 μm and more preferably 30 to 100 μm.

The solvent for the coating solution is not particularly limited but can be, for example, halogenated hydrocarbons such as chloroform, dichloromethane, carbon tetrachloride, dichloroethane, tetrachloroethane, trichloroethylene, tetrachloroethylene, chlorobenzene and orthodichlorobenzene; phenols such as phenol and parachlorophenol; aromatic hydrocarbons such as benzene, toluene, xylene, methoxybenzene and 1,2-dimethoxybenzene; ketone-based solvents such as acetone, methyl ethyl ketone, methyl isobutyl ketone, cyclohexanone, cyclopentanone, 2-pyrrolidone and N-methyl-2-pyrrolidone; ester-based solvents such as ethyl acetate and butyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol and 2-methyl-2,4-pentanediol; amide-based solvents such as dimethylformamide and dimethylacetamide; nitrile-based solvents such as acetonitrile and butyronitrile; ether-based solvents such as diethyl ether, dibutyl ether and tetrahydrofuran; or carbon disulfide, ethyl cellosolve or butyl cellosolve. These solvents may be used alone or in combination of two or more.

In the coating solution, various additives such as a stabilizer, a plasticizer, metal and the like further may be blended as necessary.

Moreover, the coating solution may contain other resins. Such resins can be, for example, resins for general purpose use, engineering plastics, thermoplastic resins and thermosetting resins.

The resins for general purpose use can be, for example, polyethylene (PE), polypropylene (PP), polystyrene (PS), polymethyl methacrylate (PMMA), an ABS resin, an AS resin or the like. The engineering plastics can be, for example, polyacetate (POM), polycarbonate (PC), polyamide (PA: nylon), polyethylene terephthalate (PET), polybutylene terephthalate (PBT) or the like. The thermoplastic resins can be, for example, polyphenylene sulfide (PPS), polyethersulfone (PES), polyketone (PK), polyimide (PI), polycyclohexanedimethanol terephthalate (PCT), polyarylate (PAR), liquid crystal polymers (LCP) or the like. The thermosetting resins can be, for example, epoxy resins, phenolic novolac resins or the like.

When the above-described other resins are blended in the coating solution as mentioned above, the blend amount ranges, for example, from 0 wt % to 50 wt %, preferably from 0 wt % to 30 wt %, with respect to the polymer material.

The coating method of the solution can be, for example, spin coating, roller coating, flow coating, printing, dip coating, film flow-expanding, bar coating or gravure printing. At the time of coating, a laminating method of polymer layers also can be adopted, as necessary.

After the coating, the solvent in the solution is removed by evaporation through natural drying, air-drying, heat drying (e.g., 60° C. to 250° C.) and the like so as to form the birefringent layer B. Though there is no particular limitation, the birefringent layer has a thickness, for example, in a range from 0.1 to 50 μm, preferably from 0.5 to 30 μm, and more preferably from 1 to 20 μm from an aspect of reducing thickness of a liquid crystal display, viewing angle compensation, film homogeneity, and the like.

It is preferable that the birefringent layer B has a difference in refractive index (nx>ny) within the surface. This is because, if the birefringent layer B has a refractive index difference within the surface and a refractive index difference between its surface and the thickness direction, namely, nx>ny>nz (nx, ny and nz are the same as described above) is satisfied, an optical film to be obtained will have an optical biaxiality. For providing the difference in refractive index within the surface of the birefringent layer B, for example, the following processes can be used. First, a base film having an in-plane shrinkage in one direction is prepared. By coating the base film with the solution and drying, the in-plane shrinkage of the base film is used to provide a difference in refractive index within the surface to the thus formed birefringent layer. Alternatively, the difference in refractive index within the surface can be provided by coating the base film applied with stress in one direction with the solution, or by forming a birefringent layer while blowing air in one direction to the coated solution. Alternatively, the difference in refractive index within the surface can be provided by coating an anisotropic base film with the solution so as to form a birefringent layer. In a further alternative process, the birefringent layer is formed on the base film layer, and then the laminate is stretched so as to provide a difference in the refractive indices within the surface of the birefringent layer. These processes can be used in combination.

The birefringent layer B can be used with the base film attached thereto. In this case, the base film has an optical anisotropy of preferably Re<10 nm and Rth<20 nm, further preferably Re<8 nm and Rth<18 nm and more preferably Re<5 nm and Rth<15 nm. It also is possible to use the base film as a transparent protective layer of the polarizer. It should be noted that Re and Rth are defined similarly to the formulae (6) and (7) described above.

It also is possible to provide a layer for ensuring adhesion between the base film and the birefringent layer B, as necessary. The material for forming this layer can be a resin based on polyethylene imine, acrylic urethane, polyester urethane or polycarbonate urethane.

In the case of forming the birefringent layer B directly in the liquid crystal cell C, similarly to the case of forming the base film, the birefringent layer B can be formed by coating the coating solution by spin coating and then removing the solvent by evaporation. Alternatively, the birefringent layer B formed on the base film may be transferred onto the liquid crystal cell C. Such a transfer is not particularly limited but may be a heat transfer or a transfer via an adhesive or a pressure-sensitive adhesive. The surface on which the birefringent layer B is formed may be either liquid crystal cell substrate on a backlight side or a visible side or inside or outside of this substrate. Especially using a highly heat resistant resin such as polyimide is preferred for providing a color filter or the like even after forming the birefringent layer B.

The birefringent layer B may be formed on one surface or both surfaces of the base film layer. Also, the birefringent layer B may be a monolayer or has a multilayered structure formed of a single material or a plurality of materials.

In the case where the birefringent layer B is used together with the base film, it is preferable further to include at least one of an adhesive layer and a pressure-sensitive adhesive layer. This makes it easier for the birefringent layer B to adhere to the other members such as the polarizing plate, the birefringent layer A and the liquid crystal cell C and also prevents the birefringent layer B from peeling off.

The material for the adhesive layer is not particularly limited but can be, for example, a polymer adhesive based on an acrylic substance, vinyl alcohol, silicone, polyester, polyurethane, polyether or the like or a rubber-based adhesive. It also may be possible to incorporate fine particles into these materials so as to form a layer showing light diffusion property. Among these materials, materials having excellent moisture absorption and heat resistance are preferable, for example. When the material with such properties is used in a liquid crystal display, for example, it is possible to provide a high-quality durable display apparatus that can prevent foaming or peeling caused by moisture absorption, degradation in the optical characteristics and warping of a liquid crystal cell caused by difference in thermal expansion coefficients and the like.

The polarizing plate according to the present invention is not particularly limited but, for example, is a laminated polarizing plate including a polarizer and a transparent protective layer. The transparent protective layer may be laminated on both surfaces of the polarizer or only on one surface thereof. Further, when they are laminated on both surfaces, the kinds of the transparent protective layers may be the same or different.

The polarizer is not particularly limited but can be a film prepared by a conventionally known method of, for example, dyeing by allowing a film of various kinds to adsorb a dichroic material such as iodine or a dichroic dye, followed by cross-linking, stretching and drying. Especially, films transmitting linearly polarized light when natural light is made to enter those films are preferable, and films having excellent light transmittance and polarization degree are preferable. Examples of the film of various kinds in which the dichroic material is to be adsorbed include hydrophilic polymer films such as polyvinyl alcohol (PVA)-based films, partially-formalized PVA-based films, partially-saponified films based on ethylene-vinyl acetate copolymer and cellulose-based films. Other than the above, polyene aligned films such as dehydrated PVA and dehydrochlorinated polyvinyl chloride can be used, for example. Among them, the PVA-based film is preferable. In addition, the thickness of the polarizer generally ranges from 1 to 80 μm, though it is not limited to this.

The transparent protective layer is not particularly limited but can be a conventionally known transparent film. For example, transparent protective films having excellent transparency, mechanical strength, thermal stability, moisture shielding property, and isotropism are preferable. Specific examples of materials for such a transparent protective layer include cellulose-based resins such as triacetylcellulose, and transparent resins based on polyester, polycarbonate, polyamide, polyimide, polyethersulfone, polysulfone, polystyrene, polynorbornene, polyolefin, acrylic substances, acetate, and the like. Thermosetting resins or ultraviolet-curing resins based on the acrylic substances, urethane, acrylic urethane, epoxy, silicones, and the like can be used as well. Among them, a TAC film having a surface saponified with alkali or the like is preferable in light of the polarization property and durability.

Moreover, for the transparent protective layer, the polymer film described in JP 2001-343529 A (WO 01/37007) also can be used. The polymer material used can be a resin composition containing a thermoplastic resin whose side chain has a substituted or unsubtituted imido group and a thermoplastic resin whose side chain has a substituted or unsubtituted phenyl group and nitrile group, for example, a resin composition containing an alternating copolymer of isobutene and N-methyl maleimide and an acrylonitrile-styrene copolymer. Alternatively, the polymer film may be formed by extruding the resin composition, for example.

In the transparent protective layer, Re and Rth in the formulae (6) and (7) described above are preferably Re<10 nm and Rth<20 nm, more preferably Re<8 nm and Rth<18 nm and further preferably Re<5 nm and Rth<15 nm.

The transparent protective layer further may have an optically compensating function. As such a transparent protective layer having the optically compensating function, it is possible to use, for example, a known layer used for preventing coloration caused by changes in a visible angle based on retardation in a liquid crystal cell or for widening a preferable viewing angle. Specific examples include various stretched films obtained by stretching the above-described transparent resins uniaxially or biaxially, an alignment film of a liquid crystal polymer or the like, and a laminate obtained by providing an alignment layer of a liquid crystal polymer on a transparent base. Among the above, the alignment film of a liquid crystal polymer is preferable because a wide viewing angle with excellent visibility can be achieved. Particularly preferable is an optically compensating retardation plate obtained by supporting an optically compensating layer with the above-mentioned triacetylcellulose film or the like, where the optically compensating layer is made of an incline-alignment layer of a discotic or nematic liquid crystal polymer. This optically compensating retardation plate can be a commercially available product, for example, “WV film” manufactured by Fuji Photo Film Co., Ltd. Alternatively, the optically compensating retardation plate can be prepared by laminating two or more layers of the retardation film and the film support of triacetylcellulose film or the like so as to control the optical characteristics such as retardation.

The thickness of the transparent protective layer is not particularly limited but can be determined suitably according to retardation or a protective strength, for example. In general, the thickness of the transparent protective layer is not more than 500 μm, preferably in the range from 5 μm to 300 μm, and more preferably in the range from 5 μm to 150 μm.

The transparent protective layer can be formed suitably by a conventionally known method such as a method of coating a polarizer with the above-mentioned various transparent resins or a method of laminating the transparent resin film, the optically compensating retardation plate or the like on the polarizing film, or can be a commercially available product.

The transparent protective layer further may be subjected to, for example, a hard coating treatment, an antireflection treatment, treatments for anti-sticking, diffusion, and anti-glaring, and the like. The hard coating treatment aims to prevent scratches on the surfaces of the polarizing plate, and is a treatment of, for example, providing a hardened coating film that is formed of a curable resin and has excellent hardness and smoothness onto a surface of the transparent protective layer. The curable resin can be, for example, ultraviolet-curing resins of silicone base, urethane base, acrylic, and epoxy base. The treatment can be carried out by a conventionally known method. The anti-sticking treatment aims to prevent adjacent layers from sticking to each other. The antireflection treatment aims to prevent reflection of external light on the surface of the polarizing plate, and can be carried out by forming a conventionally known antireflection layer or the like.

The anti-glare treatment aims to prevent reflection of external light on the polarizing plate surface from hindering visibility of light transmitted through the polarizing plate. The anti-glare treatment can be carried out, for example, by providing microscopic asperities on a surface of the transparent protective layer by a conventionally known method. Such microscopic asperities can be provided, for example, by roughening the surface by sand-blasting or embossing, or by blending transparent fine particles in the above-described transparent resin when forming the transparent protective layer.

The above-described transparent fine particles may be silica, alumina, titania, zirconia, stannic oxide, indium oxide, cadmium oxide, antimony oxide, or the like. Other than the above, inorganic fine particles having an electrical conductivity or organic fine particles including, for example, crosslinked or uncrosslinked polymer particles can be used as well. The average particle diameter of the transparent fine particles ranges, for example, from 0.5 to 20 μm, though there is no specific limitation. In general, a blend ratio of the transparent fine particles preferably ranges from 2 to 70 parts by weight, and more preferably ranges from 5 to 50 parts by weight with respect to 100 parts by weight of the above-described transparent resin, though there is no specific limitation.

An anti-glare layer in which the transparent fine particles are blended can be used as the transparent protective layer itself or provided as a coating layer or the like applied onto the transparent protective layer surface. Furthermore, the anti-glare layer also can function as a diffusion layer to diffuse light transmitted through the polarizing plate in order to widen the viewing angle (i.e., visually-compensating function).

The antireflection layer, the anti-sticking layer, the diffusion layer, and the anti-glare layer mentioned above can be laminated on the polarizing plate, as a sheet of optical layers comprising these layers, separately from the transparent protective layer.

The method of laminating the polarizer and the transparent protective layer is not particularly limited but can be a conventionally known method. In general, a pressure-sensitive adhesive or an adhesive similar to those described above can be used, and the kinds thereof can be determined suitably depending on the materials or the like of the constituent members. The adhesive can be, for example, a polymer adhesive based on acrylic substances, vinyl alcohol, silicone, polyester, polyurethane or polyether, or a rubber-based adhesive. It also is possible to use an adhesive containing a water-soluble cross-linking agent of vinyl alcohol-based polymers such as glutaraldehyde, melamine and oxalic acid. The pressure-sensitive adhesive and the adhesive mentioned above do not peel off easily even when being exposed to moisture or heat, for example, and have excellent light transmittance and polarization degree. More specifically, these pressure-sensitive adhesive and adhesive preferably are PVA-based adhesives when the polarizer is a PVA-based film, in light of stability of adhering treatment. These adhesive and pressure-sensitive adhesive may be applied directly to surfaces of the polarizer and the transparent protective layer, or a layer of a tape or a sheet formed of the adhesive or pressure-sensitive adhesive may be arranged on the surfaces thereof. Further, when these adhesive and pressure-sensitive adhesive are prepared as an aqueous solution, for example, other additives or a catalyst such as an acid catalyst may be blended as necessary. In the case of applying the adhesive, other additives or a catalyst such as an acid catalyst further may be blended in the aqueous solution of the adhesive. The thickness of the adhesive layer is not particularly limited but may be, for example, 1 to 500 nm, preferably 10 to 300 nm, and more preferably 20 to 100 nm. It is possible to adopt a known method of using an adhesive etc. such as an acrylic polymer or a vinyl alcohol-based polymer without any particular limitations. Moreover, since it becomes possible to form a polarizing plate that does not peel off easily by moisture or heat and has excellent light transmittance and polarization degree, it is preferable that the adhesive further contains a water-soluble cross-linking agent of PVA-based polymers such as glutaraldehyde, melamine and oxalic acid. These adhesives can be used, for example, by applying its aqueous solution to the surface of each constituent member mentioned above, followed by drying. In the above aqueous solution, other additives or a catalyst such as an acid catalyst may be blended as necessary. Among these, the adhesive preferably is a PVA-based adhesive because an excellent adhesiveness to a PVA film can be achieved.

The polarizing plate according to the present invention can include an additional optical layer(s) in addition to the transparent protective layer. Examples of the optical layer include various optical layers that have been conventionally known and used for forming liquid crystal displays or the like, such as a polarizing plate, a reflector, a semitransparent reflector, and a brightness-enhancement film as mentioned below. These optical layers can be used alone or in combination of at least two kinds of layers. Such an optical layer can be provided as a single layer, or two or more optical layers can be laminated. A laminated polarizing plate, which further includes such an optical layer(s), is used preferably as an integrated polarizing plate with optical compensation function, and it can be arranged on a surface of a liquid crystal cell, for example, so as to be used suitably for various image displays.

Such an integrated polarizing plate will be described below.

First, an example of a reflective polarizing plate or a semitransparent reflective polarizing plate will be described. The reflective polarizing plate is prepared by further laminating a reflector on a laminated polarizing plate according to the present invention, and the semitransparent reflective polarizing plate is prepared by further laminating a semitransparent reflector on a polarizing plate according to the present invention.

In general, such a reflective polarizing plate is arranged on a backside of a liquid crystal cell in order to make a liquid crystal display (reflective liquid crystal display) that reflects incident light from a visible side (display side). The reflective polarizing plate is advantageous in that, for example, it allows the liquid crystal display to be thinned further because the necessity of providing a light source such as backlight can be eliminated.

The reflective polarizing plate can be formed in any conventionally known manner such as forming a reflector of metal or the like on one surface of a polarizing plate having a certain elastic modulus. More specifically, one example thereof is a reflective polarizing plate formed by matting one surface (surface to be exposed) of a transparent protective layer of the polarizing plate as required, and providing the surface with a deposited film or a metal foil formed of a reflective metal such as aluminum as a reflector.

Another example is a reflective polarizing plate prepared by forming, on a transparent protective layer having a surface with microscopic asperities due to microparticles contained in various transparent resins, a reflector corresponding to the microscopic asperities. The reflector having a surface with microscopic asperities diffuses incident light irregularly so that directivity and glare can be prevented and irregularity in color tones can be controlled. The reflector can be formed by attaching the metal foil or the metal deposited film directly on the surface with asperities of the transparent protective layer by any conventionally known methods including deposition and plating, such as vacuum deposition, ion plating, and sputtering.

As mentioned above, the reflector can be formed directly on a transparent protective layer of a polarizing plate. Alternatively, a reflecting sheet or the like formed by providing a reflecting layer on a proper film such as a film used for the transparent protective layer can be used as the reflector. Since a typical reflecting layer of the reflector is made of a metal, it is preferably used in a state that the reflecting surface of the reflecting layer is coated with the film, a polarizing plate, or the like, in order to prevent a reduction of the reflectance due to oxidation, and furthermore, to allow the initial reflectance to be maintained for a long period and to avoid the necessity of forming a transparent protective layer separately.

On the other hand, a semitransparent polarizing plate is provided by replacing the reflector in the above-mentioned reflective polarizing plate by a semitransparent reflector. Examples of a semitransparent reflector include a half mirror that reflects and transmits light at the reflecting layer.

In general, the semitransparent polarizing plate is arranged on a backside of a liquid crystal cell. In a liquid crystal display including the semitransparent polarizing plate, incident light from the visible side (display side) is reflected to display an image when a liquid crystal display is used in a relatively bright atmosphere, while in a relatively dark atmosphere, an image is displayed by using a built-in light source such as a backlight on the backside of the semitransparent polarizing plate. In other words, the semitransparent polarizing plate can be used to form a liquid crystal display that can save energy for a light source such as a backlight under a bright atmosphere, while a built-in light source can be used under a relatively dark atmosphere.

The following description is directed to an example of a polarizing plate prepared by further laminating a brightness-enhancement film on a polarizing plate.

A suitable example of the brightness-enhancement film is not particularly limited, but it can be selected from a multilayer thin film of a dielectric or a laminate of multiple thin films with varied refraction anisotropy that transmits linearly polarized light having a predetermined polarization axis while reflecting other light. Examples of such a brightness-enhancement film include trade name “D-BEF” manufactured by 3M Corporation. Also, a cholesteric liquid crystal layer, more specifically, an alignment film of a cholesteric liquid crystal polymer or an alignment liquid crystal layer fixed onto a supportive film base can be used as a brightness-enhancement film. Such a brightness-enhancement film exhibits a property of reflecting one of right and left circularly polarized lights while transmitting the other light. Examples of such a brightness-enhancement film include trade name “PCF 350” manufactured by Nitto Denko Corporation, trade name “Transmax” manufactured by Merck Ltd., and the like.

An example of the various polarizing plates of the present invention as described above may be an optical member formed by laminating the polarizing plate according to the present invention and two or more additional optical layers.

An optical member including a laminate of at least two optical layers can be formed, for example, by a method of laminating layers separately in a certain order in the process for manufacturing a liquid crystal display or the like. However, efficiency in manufacturing a liquid crystal display or the like can be improved by using an optical member that has been laminated previously because of its excellent stability in quality, assembling operability, and the like. Any appropriate adhesion means such as a pressure-sensitive adhesive layer can be used for lamination as in the above.

Moreover, it is preferable that the polarizing plate described above further has a pressure-sensitive adhesive layer or an adhesive layer so as to allow easier lamination onto the other members such as a liquid crystal cell. They can be arranged on one surface or both surfaces of the polarizing plate. The material for the pressure-sensitive adhesive layer is not particularly limited but can be a conventionally known material such as acrylic polymers. In particular, the pressure-sensitive adhesive layer having a low moisture absorption coefficient and an excellent thermal resistance is preferable from the aspects of prevention of foaming or peeling caused by moisture absorption, prevention of degradation in the optical characteristics and warping of a liquid crystal cell caused by difference in thermal expansion coefficients, a capability of forming a liquid crystal display with high quality and excellent durability, and the like. It also may be possible to incorporate fine particles so as to form the pressure-sensitive adhesive layer showing light diffusion property. For the purpose of forming the pressure-sensitive adhesive layer on the surface of the polarizing plate, a solution or melt of a sticking material can be applied directly on a predetermined surface of the polarizing plate by a development method such as flow-expansion and coating. Alternatively, a pressure-sensitive adhesive layer can be formed on a separator, which will be described below, in the same manner and transferred to a predetermined surface of the polarizing plate. Such a layer can be formed on any surface of the polarizing plate. For example, it can be formed on an exposed surface of the retardation plate of the polarizing plate.

In the case where a surface of a pressure-sensitive adhesive layer or the like provided on the polarizing plate is exposed, it is preferable to cover the surface with a separator so as to prevent contamination until the pressure-sensitive adhesive layer is put to use. The separator can be made of a suitable film, e.g., the above-mentioned film used for the transparent protective layer, provided with at least one peeling coating formed of a peeling agent if required. The peeling agent may be selected, for example, from a silicone-based agent, a long-chain alkyl-based agent, a fluorine-based agent, an agent containing molybdenum sulfide, or the like.

The pressure-sensitive adhesive layer can be a monolayer or a laminate. The laminate can include monolayers different from each other in the type or in the compositions. When arranged on both surfaces of the polarizing plate, the pressure-sensitive adhesive layers can be same or can be different from each other in the type or in the compositions.

The thickness of the pressure-sensitive adhesive layer can be determined suitably depending on the structure or the like of the polarizing plate. In general, the thickness of the pressure-sensitive adhesive layer is 1 to 500 μm.

It is preferable that the pressure-sensitive adhesive layer is made of a pressure-sensitive adhesive having excellent optical transparency and appropriate sticking characteristics such as wettability, cohesiveness, and adhesiveness. The pressure-sensitive adhesive can be prepared appropriately based on polymers such as an acrylic polymer, a silicone-based polymer, polyester, polyurethane, polyether, and synthetic rubber.

Sticking characteristics of the pressure-sensitive adhesive layer can be controlled suitably by a conventionally known method. For example, the degree of cross-linkage and the molecular weight will be adjusted on the basis of a composition or molecular weight of the base polymer for forming the pressure-sensitive adhesive layer, a cross-linking method, a content ratio of the crosslinkable functional group, and a ratio of the blended cross-linking agent.

The polarizing plate, the various optical members, the transparent protective layer, the optical layer, and the pressure-sensitive adhesive layer described above may be treated with an UV absorber such as salicylate ester compounds, benzophenone compounds, benzotriazole compounds, cyanoacrylate compounds, or nickel complex salt-based compounds, thus providing an UV absorbing capability.

The liquid crystal panel according to the present invention can be produced by disposing between the two polarizing plates the birefringent layer A, the birefringent layer B and the liquid crystal cell C and attaching these constituent members with a pressure-sensitive adhesive or an adhesive. The pressure-sensitive adhesive or the adhesive are not particularly limited but can be those described above, for example. The configuration of the liquid crystal panel is not particularly limited but can be the following configurations (1) to (5), for example. The birefringent layer B in the configuration (1) below and the birefringent layer A in the configurations (4) and (5) below also serve as the transparent protective layer and are formed as one piece with the polarizer to constitute the polarizing plate. It should be noted that the visible side and the backlight side are not particularly limited in the liquid crystal panel of the present invention.

(1) Polarizing plate/Birefringent layer A/Liquid crystal cell C/Birefringent layer B/Polarizer

(2) Polarizing plate/Birefringent layer A/Liquid crystal cell C/Birefringent layer B/Polarizing plate

(3) Polarizing plate/Birefringent layer A/Birefringent layer B/Liquid crystal cell C/Polarizing plate

(4) Polarizer/Birefringent layer A/Liquid crystal cell C/Birefringent layer B/Polarizing plate

(5) Polarizer/Birefringent layer A/Birefringent layer B/Liquid crystal cell C/Polarizing plate

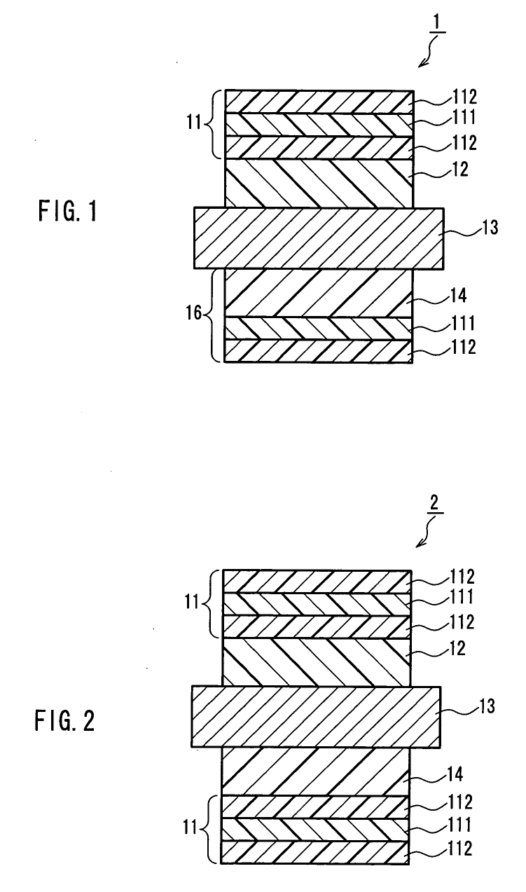

Now, FIGS. 1 to 5 illustrate an exemplary configuration of the liquid crystal panel according to the present invention. In these figures, the same portions are given the same reference signs.

The configuration of the liquid crystal panel shown in FIG. 1 corresponds to the exemplary configuration (1) described above. As shown in the figure, in this liquid crystal panel 1, a birefringent layer A 12 and a polarizing plate 11 are laminated in this order on one surface (an upper surface in the figure) of a liquid crystal cell C 13, while a birefringent layer B 14, a polarizer 111 and a transparent protective layer 112 are laminated in this order on the other surface (a lower surface in the figure) of the liquid crystal cell C 13. The polarizing plate 11 is constituted by laminating a transparent protective layer 112 on both surfaces of a polarizer 111. Also, the birefringent layer B 14 is laminated on the polarizer 111 as a transparent protective layer and forms a polarizing plate 16 together with the transparent protective layer 112.

The configuration of the liquid crystal panel shown in FIG. 2 corresponds to the exemplary configuration (2) described above. As shown in the figure, in this liquid crystal panel 2, a birefringent layer A 12 and a polarizing plate 11 are laminated in this order on one surface (an upper surface in the figure) of a liquid crystal cell C 13, while a birefringent layer B 14 and a polarizing plate 11 are laminated in this order on the other surface (a lower surface in the figure) of the liquid crystal cell C 13. The two polarizing plates 11 mentioned above are each constituted by laminating a transparent protective layer 112 on both surfaces of a polarizer 111.

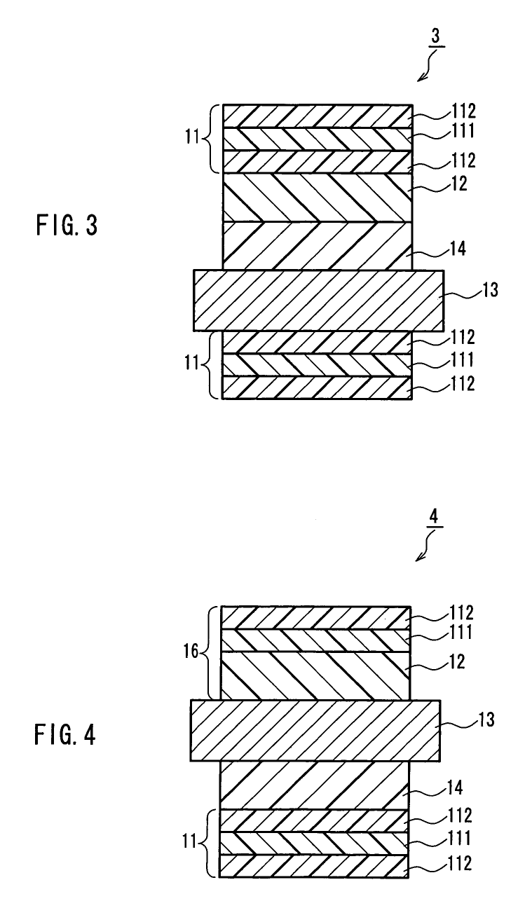

The configuration of the liquid crystal panel shown in FIG. 3 corresponds to the exemplary configuration (3) described above. As shown in the figure, in this liquid crystal panel 3, a birefringent layer B 14, a birefringent layer A 12 and a polarizing plate 11 are laminated in this order on one surface (an upper surface in the figure) of a liquid crystal cell C 13, while a polarizing plate 11 is laminated on the other surface (a lower surface in the figure) of the liquid crystal cell C 13. The two polarizing plates 11 mentioned above are each constituted by laminating a transparent protective layer 112 on both surfaces of a polarizer 111.

The configuration of the liquid crystal panel shown in FIG. 4 corresponds to the exemplary configuration (4) described above. As shown in the figure, in this liquid crystal panel 4, a birefringent layer A 12, a polarizer 111 and a transparent protective layer 112 are laminated in this order on one surface (an upper surface in the figure) of a liquid crystal cell C 13, while a birefringent layer B 14 and a polarizing plate 11 are laminated in this order on the other surface (a lower surface in the figure) of the liquid crystal cell C 13. The polarizing plate 11 is constituted by laminating a transparent protective layer 112 on both surfaces of a polarizer 111. Also, the birefringent layer A 12 is laminated on the polarizer 111 as a transparent protective layer and forms a polarizing plate 16 together with the transparent protective layer 112.

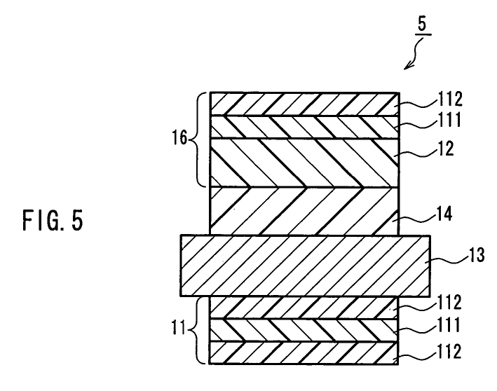

The configuration of the liquid crystal panel shown in FIG. 5 corresponds to the exemplary configuration (5) described above. As shown in the figure, in this liquid crystal panel 5, a birefringent layer B 14, a birefringent layer A 12, a polarizer 111 and a transparent protective layer 112 are laminated in this order on one surface (an upper surface in the figure) of a liquid crystal cell C 13, while a polarizing plate 11 is laminated on the other surface (a lower surface in the figure) of the liquid crystal cell C 13. The polarizing plate 11 is constituted by laminating a transparent protective layer 112 on both surfaces of a polarizer 111. Also, the birefringent layer A 12 is laminated on the polarizer 111 as a transparent protective layer and forms a polarizing plate 16 together with the transparent protective layer 112.

### EXAMPLES

The following is a description of examples of the present invention as well as comparative examples. In these examples, various characteristics were measured and evaluated in the following manner. Here, in the following examples, Δnxz=nx−nz, where nx and nz are similar to those defined in the formulae (1) and (2) above.

(Wavelength Dispersion Measurement)

Using trade name “Ellipsometer M-220” manufactured by JASCO Corporation, the retardation was measured for incident light at 40° in a wavelength range from 380 to 800 nm.

(Method for Calculating Re and Rth)

Using trade name “Ellipsometer M-220” manufactured by JASCO Corporation, the retardation was measured while inclining a sample from 0° to 40° at a wavelength of 550 nm, thus determining Re and Rth.

(Viewing Angle Characteristics)

The viewing angle characteristics of a liquid crystal display were measured using trade name “EZ-Contrast” manufactured by ELDIM SA.

### Comparative Example 1

First, 50 parts by weight of an alternating copolymer of isobutene and N-methyl maleimide (the content of N-methyl maleimide: 50 mol %) and 50 parts by weight of an acrylonitrile-styrene copolymer whose acrylonitrile content was 28 wt % were dissolved in methylene chloride, thus obtaining a solution with a solid concentration of 15 wt %. This solution was flow-expanded onto a polyethylene terephthalate (PET) film placed on a glass plate, allowed to stand for 60 minutes at room temperature and then peeled off from the PET film, followed by drying at 100° C. for 10 minutes, at 140° C. for 10 minutes and further at 160° C. for 30 minutes, thus obtaining a transparent film (I). In order to improve a mechanical strength, this film was stretched biaxially in two orthogonal directions at 135° C., thus obtaining a 50 μm thick transparent film X. The transparent film X had d=38 μm, Re=1 nm and Rth=(nx−nz)d=5 nm.

Both sides of a polarizer prepared by allowing a polyvinyl alcohol-based film to adsorb iodine and stretching this film were provided with a transparent film by attaching via an adhesive, thereby forming a polarizing plate.

A film of trade name “ARTON” manufactured by JSR Corporation was stretched uniaxially in a longitudinal direction at 175° C., thus obtaining a birefringent layer A (1) with Re=142 nm and nx>ny=nz.

Polyimide synthesized by 2,2′-bis(3,4-dicarboxyphenyl)hexafluoropropane) and 2,2′-bis(trifluoromethyl)-4,4′-diaminobiphenyl) was dissolved in meso-isobutyl ketone and prepared to be 20 wt %. The transparent film X was coated with this solution and dried at 120° C. for 5 minutes. In this way, a birefringent layer B (1) with d=5.5 μm, Re=1.1 nm, Rth=205 nm, Δnxz=0.037 and nx=ny>nz was obtained.

Using a pressure-sensitive adhesive, the polarizing plate and the birefringent layer A (1) were attached to each other such that an absorption axis of the former and a slow axis of the latter were orthogonal to each other. After the transparent film X was provided on one side of the polarizer, the birefringent layer B (1) was attached to the other side of the polarizer via an adhesive. Then, they were attached to the upper and lower surfaces of a VA-mode liquid crystal cell C via a pressure-sensitive adhesive such that the absorption axes of the polarizers described above were orthogonal to each other, thus obtaining a liquid crystal panel (I). This liquid crystal panel had a configuration shown in FIG. 1. The above-mentioned VA-mode liquid crystal cell C was obtained by peeling off a polarizing plate from a monitor (product number: LL-T1620) manufactured by SHARP CORPORATION.

### Example 1

First, a film of trade name “Pureace WR” manufactured by TEIJIN LIMITED was stretched uniaxially in a longitudinal direction at 230° C., thus obtaining a birefringent layer A (2) with Re=145 nm and nx>ny=nz.

Using a pressure-sensitive adhesive, the polarizing plate of Comparative example 1 and the birefringent layer A (2) were attached to each other such that an absorption axis of the former and a slow axis of the latter were orthogonal to each other. On the other hand, an elliptical polarizing plate having the birefringent layer B (1) similarly to Comparative example 1 was used. Then, they were attached to the upper and lower surfaces of the liquid crystal cell C of Comparative example 1 via a pressure-sensitive adhesive such that the absorption axes of the two polarizers described above were orthogonal to each other, thus obtaining a liquid crystal panel (II). This liquid crystal panel had a configuration shown in FIG. 1.

### Example 2

First, a film of trade name “Pureace WR” manufactured by TEIJIN LIMITED was subjected to fixed-end transverse stretching at 230° C., thus obtaining a birefringent layer A (3) with Re=110 nm, Rth=160 nm and nx>ny>nz.

Polyimide synthesized by 2,2′-bis(3,4-dicarboxyphenyl)hexafluoropropane) and 2,2′-bis(trifluoromethyl)-4,4′-diaminobiphenyl) TFMB was dissolved in methyl isobutyl ketone and prepared to be 20 wt %. A PET film was coated with this solution and dried at 170° C. for 5 minutes. In this way, a birefringent layer B (3) with d=4.3 μm, Re=0.8 nm, Rth=172 nm, Δnxz=0.04 and nx=ny>nz was obtained.

The transparent protective layer of Comparative example 1 was attached to one side of the polarizer via an adhesive, while the birefringent layer A (3) was attached to the other side of the polarizer via an adhesive such that a slow axis of the former and an absorption axis of the latter were orthogonal to each other. Furthermore, the birefringent layer B (3) was transferred onto the birefringent layer A (3) via a pressure-sensitive adhesive, thus producing an elliptical polarizing plate. Also, the transparent protective layer of Comparative example 1 was attached to both sides of the polarizer via an adhesive, thus obtaining the polarizing plate.

The elliptical polarizing plate was attached to one side of the liquid crystal cell C identical with that of Comparative example 1 via a pressure-sensitive adhesive, while the polarizing plate was attached to the other side thereof such that the absorption axes of these polarizers were orthogonal to each other, thus obtaining a liquid crystal panel (III).

### Example 3

First, a film of trade name “Pureace WR” manufactured by TEIJIN LIMITED was stretched uniaxially in a longitudinal direction at 230° C., thus obtaining a birefringent layer A (4) with Re=97 nm and nx>ny=nz.

Polyimide synthesized by 2,2′-bis(3,4-dicarboxyphenyl)hexafluoropropane) and 2,2′-bis(trifluoromethyl)-4,4′-diaminobiphenyl) was dissolved in methyl isobutyl ketone and prepared to be 20 wt %. A TAC film was coated with this solution and dried at 130° C. for 5 minutes. Thereafter, the TAC film alone was subjected to fixed-end transverse stretching at 150° C., thus obtaining a birefringent layer B (4) with d=5.3 μm, Re=25 nm, Rth=235 nm, Δnxz=0.044 and nx>ny>nz. Using a pressure-sensitive adhesive, the polarizing plate of Comparative example 1 and the birefringent layer A (4) were attached to each other such that an absorption axis of the former and a slow axis of the latter were orthogonal to each other, and the other polarizing plate and the birefringent layer B (4) were attached to each other such that an absorption axis of the former and a slow axis of the latter were orthogonal to each other. Then, they were attached to the upper and lower surfaces of the liquid crystal cell C of Comparative example 1 via a pressure-sensitive adhesive such that the absorption axes of the two polarizers described above were orthogonal to each other, thus obtaining a liquid crystal panel (IV).

### Comparative Example 2

A TAC film manufactured by Fuji Photo Film Co., Ltd. was attached to both sides of a polarizer via an adhesive, thus producing a polarizing plate. Incidentally, the TAC film had Re=0.7 nm and Rth=59 nm.

Polycarbonate was stretched uniaxially in a longitudinal direction, thus obtaining a birefringent layer A (6) with Re=105 nm and nx>ny=nz.

Polyimide synthesized by 2,2′-bis(3,4-dicarboxyphenyl)hexafluoropropane) and 2,2′-bis(trifluoromethyl)-4,4′-diaminobiphenyl) was dissolved in methyl isobutyl ketone and prepared to be 20 wt %. The above-described TAC film was coated with this solution and dried at 130° C. for 5 minutes. In this way, a birefringent layer B (6) with d=3.5 μm, Re=0.5 nm, Rth=145 nm, Δnxz=0.041 and nx=ny>nz was obtained.

Using a pressure-sensitive adhesive, the polarizing plate and the birefringent layer A (6) were attached to each other such that an absorption axis of the former and a slow axis of the latter were orthogonal to each other. On the other hand, the birefringent layer B (6) together with the base was attached to the polarizer, whose one side is provided with a TAC film by attaching, via an adhesive such that the TAC film is located on the side of the polarizer. Then, they were attached to the upper and lower surfaces of the liquid crystal cell via a pressure-sensitive adhesive such that the absorption axes of the polarizers described above were orthogonal to each other, thus obtaining a liquid crystal panel (VI). This liquid crystal panel had a configuration shown in FIG. 1.

### Comparative Example 3

A film of trade name “ARTON” manufactured by JSR Corporation was stretched uniaxially to 1.2 times its original length in a longitudinal direction at 175° C., thus obtaining a birefringent layer A (7) with Re=97 nm and nx>ny=nz. Then, similarly to Comparative example 2 except that the birefringent layer A (6) was replaced by the birefringent layer A (7), a liquid crystal panel (VII) was obtained. This liquid crystal panel had a configuration shown in FIG. 1.

With respect to thus obtained liquid crystal panels of Examples 1 to 3 and Comparative examples 1 to 3, the wavelength dispersion characteristics (α40) and the viewing angle characteristics of their constituent members were examined. The results are shown in Tables 1 and 2 below.

TABLE 1
Wavelength dispersion

| Liquid crystal cell: α40C = 1.079 | α40A | α40B |
|---|---|---|
| Comparative example 1 | 1.006 | 1.109 |
| Example 1 | 0.891 | 1.109 |
| Example 2 | 0.900 | 1.105 |
| Example 3 | 0.891 | 1.110 |
| Comparative example 2 | 1.100 | 1.103 |
| Comparative example 3 | 1.003 | 1.103 |

TABLE 2
Viewing angle characteristics

| | | Con- | Color shift in |
|---|---|---|---|
| | Wavelength dispersion | trast | black state (x, y) |
| Comp. | α(B) > α(C) > α(A) > 1 | ◯ | (0.327, 0.324) Δ slightly red |
| ex. 1 | | | |
| Ex. 1 | α(B) > α(C) > 1 > α(A) | ◯ | (0.315, 0.310) ⊚ |
| Ex. 2 | α(B) > α(C) > 1 > α(A) | ◯ | (0.317, 0.311) ⊚ |
| Ex. 3 | α(B) > α(C) > 1 > α(A) | ◯ | (0.318, 0.312) ⊚ |
| Comp. | α(B) > α(A) > α(C) | ◯ | (0.385, 0.397) × tinged with |
| ex. 2 | | | red |
| Comp. | α(B) > α(C) > α(A) > 1 | ◯ | (0.351, 0.370) × tinged with |
| ex. 3 | | | red |

Contrast in all directions:
◯ indicates the case not smaller than 10.
Color shift: (x, y) when an azimuth angle was 45° and a polar angle was 60° in the state of black display was measured and visually observed. As the values are closer to (x, y) = (0.31, 0.31), the color becomes more neutral (CIE 1931 color system).

As becomes clear from Tables 1 and 2 above, the liquid crystal panels of Examples satisfying the conditions of the present invention had an excellent contrast and were able to suppress color shifting effectively. In contrast, the liquid crystal panels of Comparative examples had an excellent contrast but were unable to suppress color shifting.

As described above, the liquid crystal panel according to the present invention has a high contrast ratio over a wide range and can suppress color shifting effectively. Accordingly, a liquid crystal display using the liquid crystal panel according to the present invention achieves an excellent display quality.

What is claimed is:

1. A liquid crystal panel comprising:
two polarizing plates;
a birefringent layer A;
a birefringent layer B; and
a liquid crystal cell C;
wherein the two polarizing plates are arranged such that their absorption axes are substantially orthogonal to each other,
the birefringent layer A, the birefringent layer B and the liquid crystal cell C are arranged between the two polarizing plates,
the birefringent layer A has a refractive index anisotropy represented by the formula (1) below,
the birefringent layer B has a refractive index anisotropy represented by the formula (2) below,
the liquid crystal cell C is a liquid crystal cell whose liquid crystal molecules are aligned substantially vertically when no voltage is applied, and
a wavelength dispersion characteristic (α40(A)) of the birefringent layer A, the birefringent layer B (α40(B)) and (α40(C)) of the liquid crystal cell C satisfy conditions represented by the formulae (3) and (4) below,
nx>ny≧nz Formula (1)
nx≧ny>nz Formula (2)
where nx, ny and nz respectively represent refractive indices in an X-axis direction, a Y-axis direction and a Z-axis direction in the birefringent layers A and B, with the X-axis direction being an axial direction exhibiting a maximum refractive index within a surface of each of the birefringent layers A and B, the Y-axis direction being an axial direction perpendicular to the X-axis direction within the surface of each of the birefringent layers A and B and the Z-axis direction being a thickness direction perpendicular to the X-axis direction and the Y-axis direction,
α40(B)>α40(C)>α40(A) Formula (3)
1>α40(A) Formula (4)
where the wavelength dispersion characteristic α40 represents a ratio of a retardation (Re) measured with an incident light at 430 nm to that measured with an incident light at 550 nm, the incident lights being inclined by 40° with respect to a normal direction (0°) of a surface of the birefringent layer or a surface of the liquid crystal cell, as shown in the formula (5) below.
α40=Re(430 nm)/Re(550 nm) Formula (5)
Re(430 nm): the retardation measured with the incident light at 430 nm
Re(550 nm): the retardation measured with the incident light at 430 nm

2. The liquid crystal panel according to claim 1, wherein a difference in the refractive index (Δn=nx−ny, where nx and ny are the same as those in the formula (2)) within the surface of the birefringent layer B ranges from 0.005 to 0.2.

3. The liquid crystal panel according to claim 1, wherein the birefringent layer B is formed of a non-liquid crystal material.

4. The liquid crystal panel according to claim 1, wherein the non-liquid crystal material is formed of at least one resin selected from the group consisting of polyamide, polyimide, polyester, polyetherketone, polyamide imide and polyesterimide.

5. The liquid crystal panel according to claim 1, wherein the polarizing plate comprises a polarizer and transparent protective layers laminated on both surfaces of the polarizer, and
one of the transparent protective layers that is located on a side of the liquid crystal cell C satisfies conditions represented by the formulae (6) and (7):
Re=(nx−ny)d<10 nm Formula (6)
Rth=(nx−nz)d<20 nm Formula (7)
where nx, ny and nz are the same as those in the formulae (1) and (2).

6. The liquid crystal panel according to claim 1, wherein the birefringent layer B and the liquid crystal cell C are arranged adjacent to each other.

7. The liquid crystal panel according to claim 1, wherein the birefringent layer A and the birefringent layer B are laminated in this order on one of the polarizing plates.

8. The liquid crystal panel according to claim 1, wherein the birefringent layer A and the birefringent layer B are laminated in this order on one of the polarizing plates, and
the birefringent layer A is laminated on a polarizer of one of the polarizing plates, the birefringent layer A also serves as the transparent protective layer, a slow axis of the birefringent layer A and an absorption axis of the polarizer are substantially orthogonal to each other, and the birefringent layer B is laminated on the birefringent layer A.

9. A liquid crystal display comprising the liquid crystal panel according to claim 1.
